(19) United States
(12) Patent Application Publication
(10) Pub. No.: US 2010/0223993 A1
(43) Pub. Date: Sep. 9, 2010

(54) FLUID LEVEL DETECTION DEVICE

(75) Inventors: Takafumi Shimizu, Shimada-shi (JP); Toshio Ohike, Shimada-shi (JP); Toshiaki Fukuhara, Shimada-shi (JP)

Correspondence Address: SUGHRUE-265550, 2100 PENNSYLVANIA AVE. NW, WASHINGTON, DC, 20037-3213, US

(73) Assignee: YAZAKI CORPORATION, TOKYO (JP)

(21) Appl. No.: 12/717,594

(22) Filed: Mar. 4, 2010

(30) Foreign Application Priority Data
Mar. 6, 2009 (JP) 2009-053606

(51) Int. Cl. G01F 23/32

(52) U.S. Cl. 73/317

(57) ABSTRACT

A fluid level detection device includes a float floating in a bio fuel, a float arm, and a sensor for detecting a rotating amount of the float arm. The sensor has a circuit board and a sliding contact having a contact portion. The float arm is made of a stainless steel based material. The contact portion of the sliding contact and a metallic piece extended from the contact portion are made of nickel silver, and a Ni plating layer is applied to a surface of the nickel silver. A current of 10 ms to 15 ms per cycle is supplied to the resistor and the contact portion.

### BACKGROUND

The present invention relates to a fluid level detection device for automatically detecting a residual amount of a fluid stored in an interior of a fuel tank of a transportation vehicle such as a vehicle and an airplane. The invention relates particularly to a fluid level detection device adapted to detect a fluid level of a bio fuel (a biomass fuel) such as a bio ethanol fuel and a bio diesel fuel which is easy to be oxidized for deterioration.

Due to rising awareness of the global environment or from the viewpoint of safety, the use of bio fuel such as bio ethanol fuel and bio diesel fuel is being propagated widely on a global basis as an alternative fuel for the gasoline fuel which is currently used for motor vehicles. Needless to say, the bio ethanol fuel is a fuel produced through ethanol fermentation from a material such as starch or sugar which is extracted from biomass resources such as corn and sugar cane. In the bio ethanol fuel including blended gasoline fuel which is used as such an alternative fuel, approximately 10 to 100% ethanol is contained.

On the other hand, the bio diesel fuel uses a FAME blended light oil which is a blend of various types of fatty acid methyl esters and contains 5 to 30% or less fatty acid methyl ester (FAME) which is produced through methylation or ethylation of colza oil, soybean oil, palm oil, waste food oil or the like.

In general, the bio ethanol fuel has a relatively strong polarity, which triggers problems of corroding metal-base materials and deteriorating resin-base materials due to swelling effect. It is said that the bio diesel fuel calls for corrosion of metal materials and early deterioration of rubber and resin materials due to acid and deterioration based on oxidation.

Incidentally, there is a situation in which a fluid level detection device is used to detect a residual amount of bio ethanol fuel or bio diesel fuel which is stored in a fuel tank.

Here, an example of a fluid level detection device will be described. FIG. 4 is an electrical block diagram which describes an example of a construction used in a sensor which is used in a conventional fluid level detection device as well as one according to the invention. FIG. 5 is an explanatory diagram which describes an example of a construction used in the conventional fluid level detection device as well as the fluid level detection device of the invention. FIG. 6 is an explanatory diagram which describes an example of a construction of a variable resistance used in an interior of the sensor used in the conventional fluid level detection device as well as the fluid level detection device of the invention.

A sensor 2 of a fluid level detection device 1 includes a variable resistance 3 whose resistance value changes as contact points 19, 20, which will be described later, move in association with a transition in height of the level of a fluid in an interior of a fluid-tight container T, a fixed resistance 7 which is connected in series with the variable resistance 3 and a power supply circuit 4 for applying predetermined voltages to the variable resistance 3 and the fixed resistance 7.

Further, as is shown in FIGS. 5, 6, the sensor 2 includes further an insulated circuit board 13 which is mounted on a body frame 12 and a sliding contact 14 which is connected to the other end of a float arm 11. A float 10 which floats in the fluid by buoyancy is attached to a distal end of the float arm 11. A first conductive pattern 15 and a second conductive pattern 16 are provided on the insulated circuit board 13 of the sensor 2, and these two conductive patterns 15, 16 are disposed in the form of parallel arcs centered at a rotating shaft 21 of the float arm. An input/output conductive portion 17 is connected to one end of the first conductive pattern 15, and an input/output conductive portion 18 is connected to one end of the second conductive pattern 16.

The first conductive pattern 15 is made up of a plurality of conductive segments 15a which are disposed at predetermined intervals in a circumferential direction of the arc-like shape and a resistor 15b which electrically connects these segments to each other. The second conductive pattern 16 is made up of a plurality of conductive segments 16a which are disposed at predetermined intervals in a circumferential direction of the arc-like shape and a resistor 16b which electrically connects these segments to each other. These first and second conductive patterns 15, 16 are disposed spaced apart from each other.

The conductive segments 15a of the first conductive pattern 15 and the conductive segments 16a of the second conductive pattern 16 are made of, for example, silver palladium having a superior corrosion resistance, and the resistor 15b is made of, for example, ruthenium oxide having a superior corrosion resistance.

The two contact points 19, 20, which are electrically connected to each other, are provided on the sliding contact 14. The rotating shaft 21, which is positioned at the other end of the float arm 11, is coupled to the sliding contact 14. While the float arm 11 rotates about the rotating shaft 21 as a fulcrum in a direction indicated by an arrow in FIG. 6 as the float 10 floating in the fluid moves downwards from a level of fluid which is filling the fuel tank in accordance with an amount consumed, the sliding contact 14 also rotates in the direction indicated by the arrow in FIG. 6 as the float arm 11 so moves. When the sliding contact 14 moves rotationally, the respective contact points 19, 20 electrically connect to the respective conductive segments 15a, 16a which are disposed on the first conductive pattern 15 and the second conductive pattern 16, respectively, while sliding thereon. By doing so, the length of the resistor 15b interposed in a circuit from the input/output conductive portion 17 to the input/output conductive portion 18 changes, whereby a resistance value of the circuit changes (namely, a resistance value of the variable resistance 3 in FIG. 4 changes). In this way, the variable resistance 3 is made up of the first conductive pattern 15, the second conductive pattern 16 and the sliding contact 14.

When voltages are applied to the variable resistance 3 and the fixed resistance 7, a potential difference between the input/output conductive portions 17, 18 is detected by the sensor 2, and an output signal outputted from the sensor 2 is then outputted to a processing circuit 5. The processing circuit 5 then displays in an analog or digital fashion a residual amount of the fluid on a display such as a meter 6 based on the output signal from the sensor 2.

In the conventional fluid level detection device, in many cases, the contact points 19, 20 of the sliding contact 14 and metallic pieces which are provided continuously on the contact points 19, 20 are made of a copper alloy such as a nickel silver for spring or a phosphor bronze for spring, and a zinc-plated steel wire is generally used for the float arm 11 (Patent Document 1).

When the conventional fluid level detection device 1 that has been described heretofore is submerged in an electrolyte such as ethanol or ethanol-contained gasoline stored in the interior of the fuel tank T, the sliding contact 14, in particular, which is made of the copper alloy reacts with the electrolyte to cause a problem of a metal corrosion deterioration by electrolytic corrosion. In the case of the zinc-plated float arm, a phenomenon is induced in which zinc is dissolved, and in either of the cases, an improvement in durability of the sensor parts has been demanded.

Then, as a measure for solving the problem, a proposal has been made in which constituent parts of a sliding contact excluding contact points made of a copper alloy and a float arm are made of the same stainless steel material, so as to avoid the problem of corrosion by electrolyte to thereby improve the durability of a sensor (Patent Document 2).

[Patent Document 1] JP-A-2009-8650

[Patent Document 2] JP-A-2009-8535

However, Patent Document 1 does not take into consideration any countermeasure for preventing the deterioration of a metallic material due to corrosion by acid contained in bio fuel such as bio ethanol fuel or bio diesel fuel.

In addition, in the fluid level detection device disclosed in Patent Document 2, although it is verified that a superior advantage of realizing a corrosion resistance against electrolyte such as ethanol, methanol or ethanol contained gasoline is provided by specifying the same stainless steel as the material for the constituent member of the sliding contact and the float arm, the patent document also does not take into consideration any countermeasure for preventing the deterioration of a metallic material due to corrosion by acid contained in the bio fuel.

### SUMMARY

The invention has been made in view of the situations described above, and an object thereof is to provide a fluid level detection device which can sufficiently deal with bio fuel such as bio ethanol fuel and bio diesel fuel. In addition, another object is to realize maintenance of corrosion resistance against the aforesaid fluid, electrical conductivity and bending workability of metallic parts which touch the fluid and electric connecting parts of the fluid level detection device and improvement in durability thereof for improving detection and measurement accuracies.

In order to achieve the above object, according to the present invention, there is provided a fluid level detection device comprising:

a float which floats in a bio fuel and changes its position in accordance with a change in height of a surface of the bio fuel;

a float arm coupled to the float at one end thereof; and

a sensor which detects a rotating amount of the float arm that rotates in accordance with a change in position of the float,

wherein the sensor includes:
a circuit board on which a resistor is disposed; and a sliding contact coupled to the other end of the float arm so as to rotate in accordance with a rotation of the float arm, and that has a contact portion, an electrical connecting position of the contact portion with respect to the resistor on the circuit board being changed in accordance with a rotation of the sliding contact to detect the rotation amount of the float arm based on an electrical potential difference between voltages applied to the resistor and the contact portion;

wherein the float arm is made of a stainless steel based material;

wherein the contact portion of the sliding contact and a metallic piece extended from the contact portion are made of nickel silver, and a Ni plating layer is applied to surfaces of the contact portion and the metallic piece; and

wherein a current of 10 ms to 15 ms per cycle is supplied to the resistor and the contact portion.

Preferably, the bio fuel is a bio ethanol fuel containing 10 to 100% of ethanol.

Preferably, the bio fuel is a bio diesel fuel containing 5 to 30% of fatty methyl ether.

According to the fluid level detection device which is configured as described in the above aspects of the invention, the metal corrosion reaction by acid contained in the bio fuel (for example, bio ethanol fuel and bio diesel fuel) can be avoided which would otherwise act on the metallic parts such as the sliding contact and the float arm of the fluid level detection device which is submerged in the bio fuel within the tank. By dosing so, the corrosion resistance of the sliding contact and the float arm can be improved so as to maintain the stable measurement accuracy for a long period of time. Consequently, in the fluid level detection device, since the sliding contact and the float arm can be used which are suitable for detecting a level of bio fuel such as bio ethanol fuel or bio diesel fuel, an added value can be obtained of being made free from having to change materials of the parts due to corrosion effect caused by a type of acid contained in the bio fuel or from restrictions in designing the construction of the fluid level detection device.

According to the invention, the fluid level detection device which can sufficiently deal with the bio fuel such as bio ethanol fuel and bio diesel fuel is provided. Further, it becomes possible to realize maintenance of corrosion resistance against the aforesaid fluid, electrical conductivity and bending workability of the metallic parts which touch the fluid and the electric connecting parts of the fluid level detection device and improvement in durability thereof for improving detection and measurement accuracies.

Thus, the invention has briefly been described. Further, by perusing a mode for carrying out the invention which will be described below by reference to the accompanying drawings, the details of the invention will be clarified further.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a side view of a sliding contact that is used in a fluid level detection device according to the invention;

FIG. 2 is a plan view of the sliding contact that is used in the fluid level detection device shown in FIG. 1;

FIG. 3 is an explanatory diagram showing an embodiment of a float arm that is used in the fluid level detection device according to the invention;

FIG. 4 is an electrical block diagram illustrating an example of a construction of a sensor that is used in the fluid level detection device of the invention and in a conventional one;

FIG. 5 is an explanatory diagram illustrating an example of a construction of the fluid level detection device of the invention and in the conventional one; and

FIG. 6 is an explanatory diagram illustrating an example of a variable resistance in an interior of the sensor used in the fluid level detection device of the invention and in the conventional one.

### DETAILED DESCRIPTION OF EXEMPLARY EMBODIMENTS

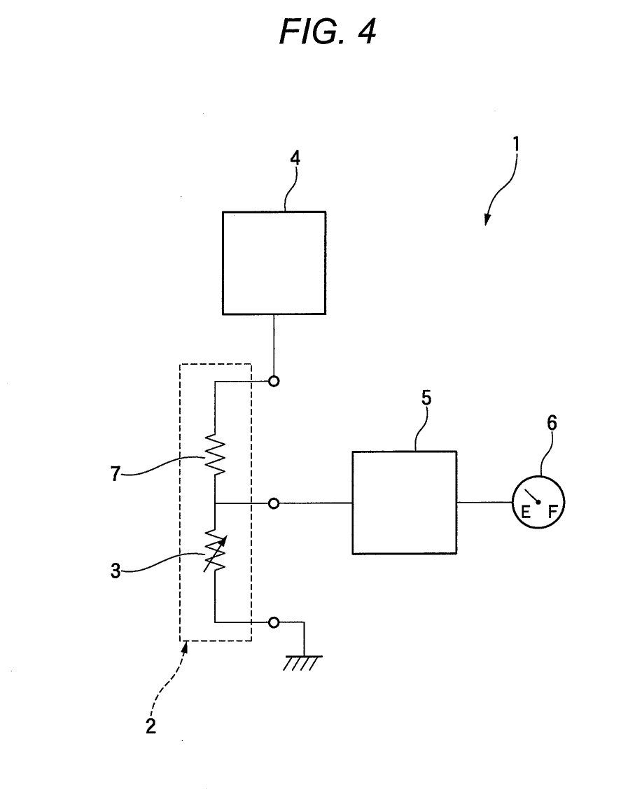

Although a basic construction of a fluid level detection device of the invention is such as to have already been described in detail by reference to FIGS. 4, 5, 6 under the description of the related art in the specification, the fluid level detection device of the invention will be described again here.

A sensor 2 of a fluid level detection device 1 includes a variable resistance 3 whose resistance value changes as contact points 19, 20, which will be described later, move in association with a transition in height of the level of a fluid in an interior of a fluid-tight container T, a fixed resistance 7 which is connected in series with the variable resistance 3 and a power supply circuit 4 for applying predetermined voltages to the variable resistance 3 and the fixed resistance 7.

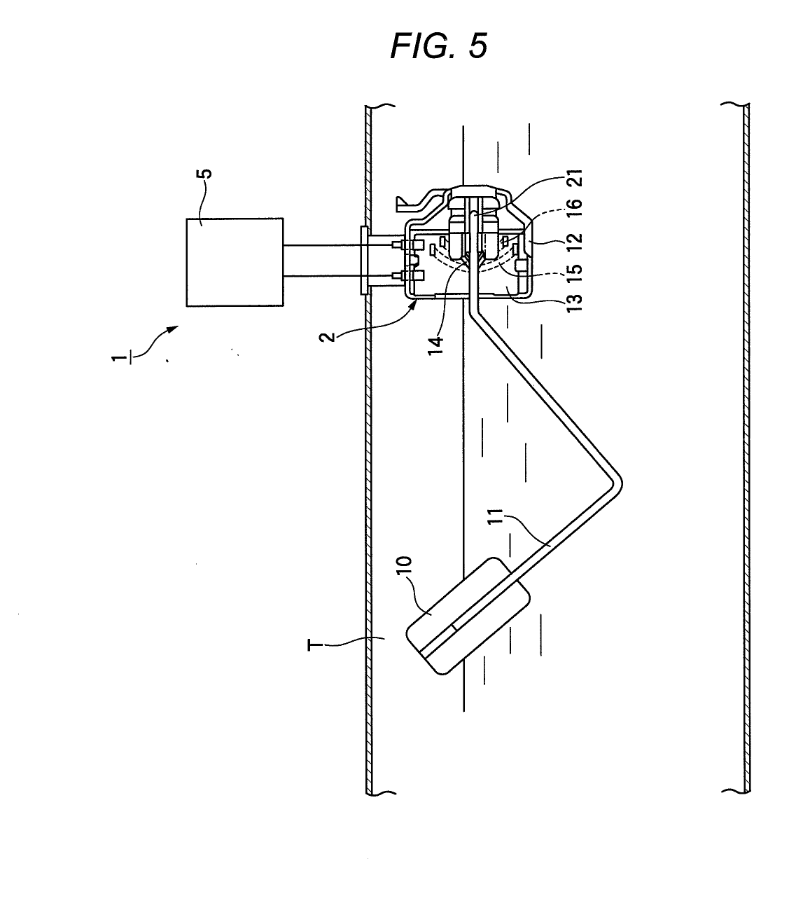

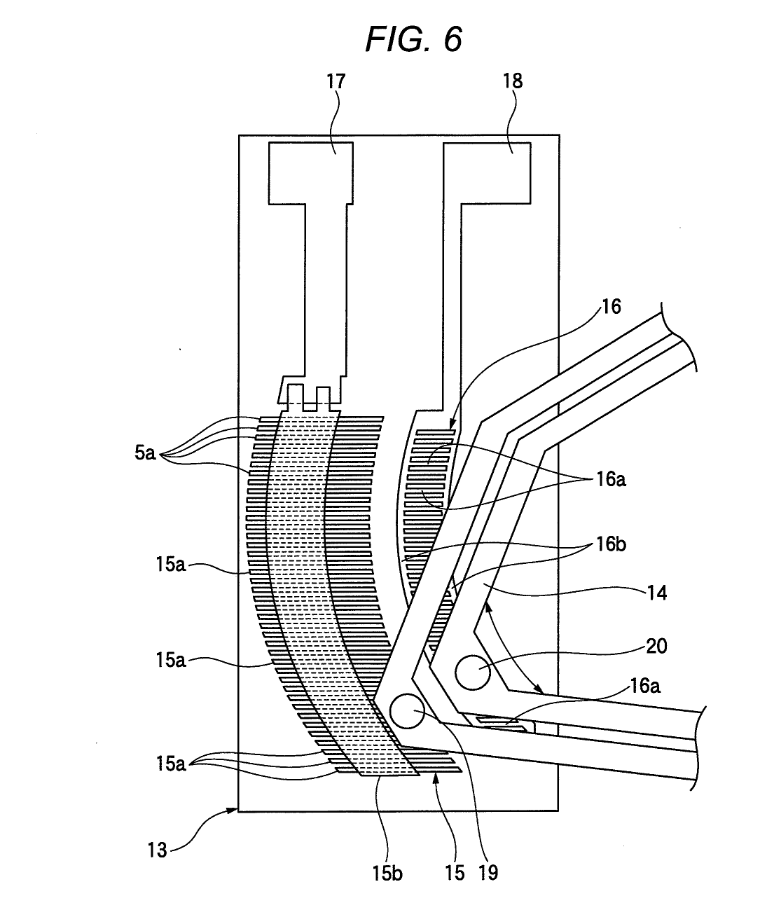

Further, as is shown in FIGS. 5, 6, the sensor 2 includes further an insulated circuit board 13 which is mounted on a body frame 12 and a sliding contact 14 which is connected to the other end of a float arm 11. A float 10 which floats in the fluid by means of buoyancy is attached to a distal end of the float arm 11. A first conductive pattern 15 and a second conductive pattern 16 are provided on the insulated circuit board 13 of the sensor 2, and these two conductive patterns 15, 16 are disposed in the form of parallel arcs centered at a rotating shaft 21 of the float arm. An input/output conductive portion 17 is connected to one end of the first conductive pattern 15, and an input/output conductive portion 18 is connected to one end of the second conductive pattern 16.

The first conductive pattern 15 is made up of a plurality of conductive segments 15a which are disposed at predetermined intervals in a circumferential direction of the arc-like shape and a resistor 15b which electrically connects these segments to each other. The second conductive pattern 16 is made up of a plurality of conductive segments 16a which are disposed at predetermined intervals in a circumferential direction of the arc-like shape and a resistor 16b which electrically connects these segments to each other. These first and second conductive patterns 15, 16 are disposed spaced apart from each other.

The conductive segments 15a of the first conductive pattern 15 and the conductive segments 16a of the second conductive pattern 16 are made of, for example, silver palladium having a superior corrosion resistance, and the resistor 15b is made of, for example, ruthenium oxide having a superior corrosion resistance.

The two contact points 19, 20, which are electrically connected to each other, are provided on the sliding contact 14. The rotating shaft 21, which is positioned at the other end of the float arm 11, is coupled to the sliding contact 14. While the float arm 11 rotates about the rotating shaft 21 as a fulcrum in a direction indicated by an arrow in FIG. 6 as the float 10 floating in the fluid moves downwards from a level of fluid which is filling the fuel tank in accordance with an amount consumed, the sliding contact 14 also rotates in the direction indicated by the arrow in FIG. 6 as the float arm 11 so moves. When the sliding contact 14 moves rotationally, the respective contact points 19, 20 electrically connect to the respective conductive segments 15a, 16a which are disposed on the first conductive pattern 15 and the second conductive pattern 16, respectively, while sliding thereon. By doing so, the length of the resistor 15b interposed in a circuit from the input/output conductive portion 17 to the input/output conductive portion 18 changes, whereby a resistance value of the circuit changes (namely, a resistance value of the variable resistance 3 in FIG. 4 changes). In this way, the variable resistance 3 is made up of the first conductive pattern 15, the second conductive pattern 16 and the sliding contact 14.

When voltages are applied to the variable resistance 3 and the fixed resistance 7, a potential difference between the input/output conductive portions 17, 18 is detected by the sensor 2, and an output signal outputted from the sensor 2 is then outputted to a processing circuit 5. The processing circuit 5 then displays in an analog or digital fashion a residual amount of the fluid on a display such as a meter 6 based on the output signal from the sensor 2.

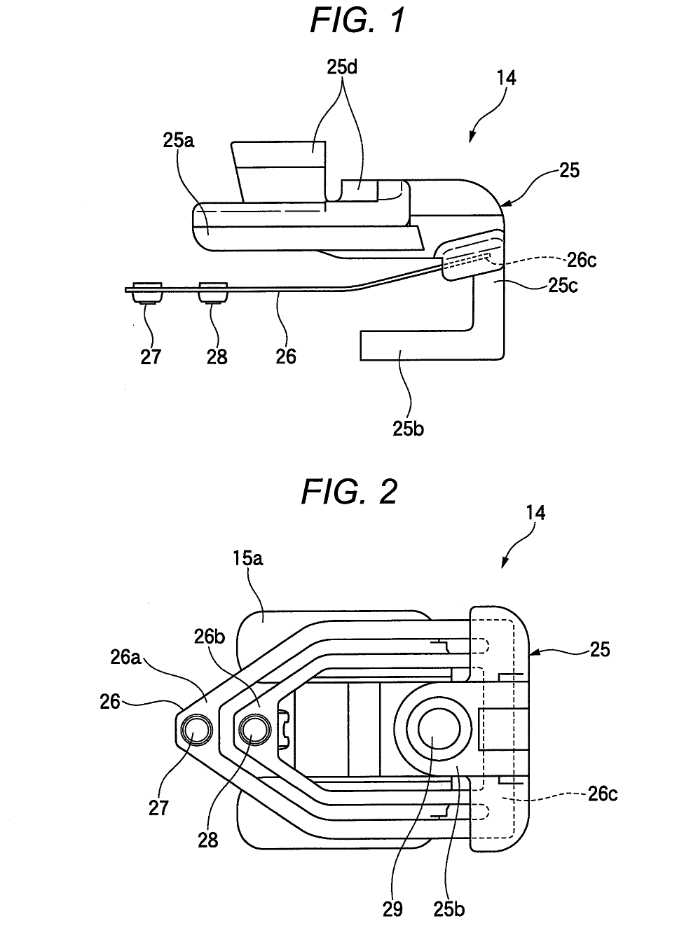

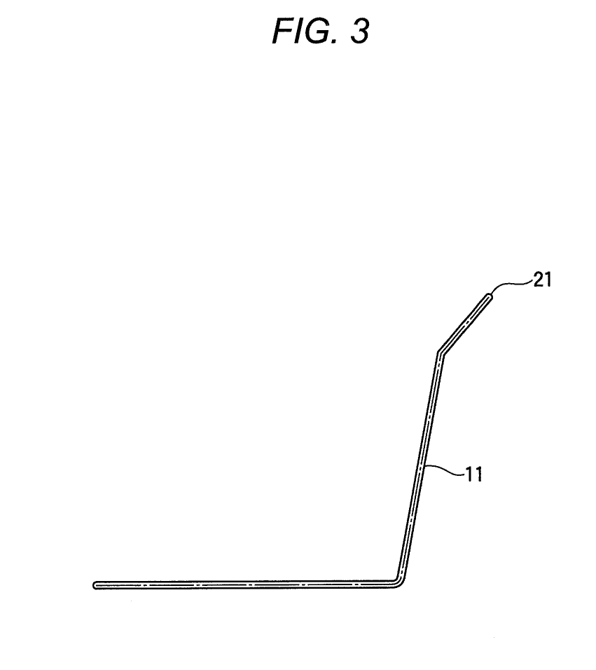

Hereinafter, an example of a construction of the sensor which includes constituent members of the sling contact and structural members of the float arm according to the invention will be described by reference to FIGS. 1, 2, 3. FIG. 1 is a side view of the sliding contact that is used in the fluid level detection device according to the invention. FIG. 2 is a plan view of the sliding contact that is used in the fluid level detection device shown in FIG. 1. FIG. 3 is an explanatory diagram illustrating an embodiment of a float arm that is used in the fluid level detection device according to the invention.

In FIGS. 1, 2, the sliding contact 14 in the sensor 2 includes an arm holder 25, a contact point spring 26, and a first contact point 27 (corresponding to the contact point 19 in FIG. 6) and a second contact point 28 (corresponding to the contact point 20 in FIG. 6) which are secured to one end of the contact point spring 26. The arm holder 25 is formed from a synthetic resin into substantially a U-shape as viewed from a side thereof through injection molding and has an upper holding portion 25a and a lower holding portion 25b. The upper holding portion 25a and the lower holding portion 25b are formed parallel to each other and are coupled together by a coupling portion 25c.

A shaft hole 29 through which the rotating shaft 21 at the rear end of the float arm 11 is inserted is formed in each of the upper holding portion 25a and the lower holding portion 25b so as to penetrate therethrough. A pair of side walls 25d is provided on an upper surface of the upper holding portion 25a so as to be at right angles to the float arm 11, so that side surfaces of the float arm 11 in which the rotating shaft 21 is inserted through the shaft holes 29 are held by the pair of side walls 25d. By doing so, the arm holder 25 rotates as does the float arm 11 which changes its rotating angle in association with a change in level of the fluid. Namely, the sliding contact 14 rotates. As is shown in FIG. 3, the float arm 11 is fabricated by bending a stainless steel wire in a perpendicular direction at a substantially central portion thereof. A float 10 shown in FIG. 5 is attached to a front end of the float arm 11, and the rotating shaft 21 at the rear end of the float arm 11 is inserted through the shaft holes 29.

The contact point spring 26 is formed of a copper alloy such as a nickel silver (copper-nickel-zinc alloys) for spring into a thin plate, and a Ni plating is applied to a surface of the thin plate like contact point spring 26. In this contact point spring 26, a first contact point holding portion 26a and a second contact point holding portion 26b, which are both formed of a thin plate into a V-shape, are disposed parallel to each other. The first contact point holding portion 26a and the second contact point holding portion 26b are coupled to each other at a proximal end portion 26c of the contact pint spring 26 to thereby establish electrical communication. The upper holding portion 25a of the arm holder 25 is fixed to the proximal end portion 26c. The first contact point 27, which slides over the first conductive pattern 15, is secured to a distal end of the first contact point holding portion 26a, and the second contact point 28, which slides over the second conductive pattern 16, is secured to a distal end of the second contact point holding portion 26b. The first contact point 27 and the second contact point 28 are formed of the nickel silver as that of the contact spring 26, and similarly, a Ni plating is applied to a surface of each of the first and second contact points 27, 28.

The contact point spring 26, which is made of the nickel silver, has, of course, electrical conductivity and elasticity, and by means of the elasticity the first contact point 27 and the second contact point 28 are pressed against the first conductive pattern 15 and the second contact pattern 16, respectively. By the first contact point 27 and the second contact point 28 of the sliding contact 14 being brought into contact with the conductive segment 15a which corresponds to a position of the rotating sliding contact 14 and the conductive segment 16a which corresponds to the position of the rotating sliding contact 14, respectively, the conductive segment 15a with which the first contact point 27 is in contact and the conductive segment 16a with which the second contact point 28 is in contact are electrically connected together by the contact point spring 26.

According to the fluid level detection device of the invention, since the contact point spring 26, which is the structural member of the sliding contact 14 including the first contact point 27 and the second contact point 28 which are submerged in the electrolyte in the fuel tank, is made of the nickel silver, an oxide layer is produced on the surface of the Ni plating against the bio ethanol fuel containing 10 to 100% ethanol or the bio diesel fuel containing 5 to 30% fatty acid methyl ester, whereby a passive film having a high corrosion resistance can be formed over the whole of a metal surface of the sliding contact which makes up the contact point spring 26 which includes the first contact point 27 and the second contact point 28. Because of this, the propagation of metal corrosion deterioration can be prevented which would otherwise be caused when an oxide produced by copper (Cu) that would be precipitated from the contact parts made of the nickel silver sticks to a negative pole of the resistance plate of the sensor.

According to the fluid level detection device of the invention, since the float arm which is submerged in the electrolyte in the fuel tank is made of the stainless steel wire, chrome (Cr) contained in stainless steel is precipitated so that an oxide coat is formed on the surface of the float arm, the corrosion resistance against the bio ethanol fuel or the bio diesel fuel works on the float arm, thereby making it possible to ensure the durability and reliability thereof.

Incidentally, in the sensor 2, although the predetermined voltages are applied to the variable resistance 3 and the fixed resistance 7 from the power supply circuit 4 for outputting a signal in accordance with a resistance value of the variable resistance 3, it is known that by making an energization time for applying a voltage to the sensor 2 be 15 ms or less per cycle, an electrochemical reaction such as electrolytic corrosion in the sliding contact 14 is suppressed to thereby avoid oxidation deterioration. In this embodiment, too, the energization time for applying a voltage to the sensor 2 from the power supply circuit 4 is set to fall within a range from 10 to 15 ms. By doing so, with the energization time per cycle being 10 ms to 15 ms or less, a time to be spent to a point where the current value starts to rise becomes 60 s or more, whereby the elution of metallic ions is highly suppressed, and even when submerged in electrolyte, an electrochemical reaction such as electrolytic corrosion at the contact points of the variable resistance of the sensor 2 can be suppressed. Thus, a stable, highly accurate detection can be implemented over a long period of time.

Although the invention has been illustrated and described for the particular preferred embodiments, it is apparent to a person skilled in the art that various changes and modifications can be made on the basis of the teachings of the invention. It is apparent that such changes and modifications are within the spirit, scope, and intention of the invention as defined by the appended claims.

The present application is based on Japanese Patent Application No. 2009-053606 filed on Mar. 6, 2009, the contents of which are incorporated herein for reference.

What is claimed is:

1. A fluid level detection device comprising:
a float which floats in a bio fuel and changes its position in accordance with a change in height of a surface of the bio fuel;
a float arm coupled to the float at one end thereof; and
a sensor which detects a rotating amount of the float arm that rotates in accordance with a change in position of the float,
wherein the sensor includes:
a circuit board on which a resistor is disposed; and
a sliding contact coupled to the other end of the float arm so as to rotate in accordance with a rotation of the float arm, and that has a contact portion, an electrical connecting position of the contact portion with respect to the resistor on the circuit board being changed in accordance with a rotation of the sliding contact to detect the rotation amount of the float arm based on an electrical potential difference between voltages applied to the resistor and the contact portion;
wherein the float arm is made of a stainless steel based material;
wherein the contact portion of the sliding contact and a metallic piece extended from the contact portion are made of nickel silver, and a Ni plating layer is applied to surfaces of the contact portion and the metallic piece; and
wherein a current of 10 ms to 15 ms per cycle is supplied to the resistor and the contact portion.

2. The fluid level detection system according to claim 1, wherein the bio fuel is a bio ethanol fuel containing 10 to 100% of ethanol.

3. The fluid level detection device according to claim 1, wherein the bio fuel is a bio diesel fuel containing 5 to 30% of fatty methyl ether.
